(19) United States
(12) Patent Application Publication
(10) Pub. No.: US 2014/0091231 A1
(43) Pub. Date: Apr. 3, 2014

(54) INHIBITING OPEN CHANNEL FLOW IN WATER TUBES OF AN ULTRAVIOLET FLUID DISINFECTION SYSTEM

(71) Applicant: ENAQUA, Vista, CA (US)

(72) Inventor: Manoj Kumar Jhawar, San Marcos, CA (US)

(73) Assignee: ENAQUA, Vista, CA (US)

(21) Appl. No.: 14/025,644

(22) Filed: Sep. 12, 2013

Related U.S. Application Data
(60) Provisional application No. 61/707,404, filed on Sep. 28, 2012.
(60) Provisional application No. 61/707,413, filed on Sep. 28, 2012.
(60) Provisional application No. 61/707,423, filed on Sep. 28, 2012.

(51) Int. Cl. C02F 1/32

(52) U.S. Cl. CPC C02F 1/32
USPC 250/435; 250/432 R

(57) ABSTRACT

An ultraviolet-based disinfection system is presented here. The system includes a fluid flow tube configured to accommodate fluid to be treated, and an ultraviolet energy source adjacent to the fluid flow tube. The ultraviolet energy source is configured to emit ultraviolet energy for treating fluid flowing within the fluid flow tube. The fluid flow tube is configured to inhibit open channel flow conditions and to promote plug flow conditions.

### CROSS-REFERENCE TO RELATED APPLICATION

This application claims the benefit of: U.S. provisional patent application No. 61/707,404, filed Sep. 28, 2012 (titled Intelligent Control Of Lamps In An Ultraviolet Water Disinfection System); U.S. provisional patent application No. 61/707,413, filed Sep. 28, 2012 (titled Inhibiting Open Channel Flow In Water Tubes Of An Ultraviolet Water Disinfection System); and U.S. provisional patent application No. 61/707,423, filed Sep. 28, 2012 (titled Lamp Fixture With Onboard Memory Circuit, And Related Lamp Monitoring System). The content of these provisional applications is incorporated by reference herein.

### TECHNICAL FIELD

Embodiments of the subject matter described herein relate generally to water treatment systems and related methodologies. More particularly, embodiments of the subject matter relate to ultraviolet (UV) water disinfection systems.

### BACKGROUND

Water treatment systems that use ultraviolet light to disinfect a flow of water are known. A number of ultraviolet-based water treatment systems, arrangements, and architectures have been developed, and such systems utilize the basic disinfecting properties of ultraviolet light. See, for example, the following documents: Anderson, U.S. Pat. No. 6,099,799; Heimer, U.S. Pat. No. 6,303,086; Saccomanno, U.S. Pat. No. 7,169,311; Saccomanno, U.S. Pat. No. 7,498,004; Saccomanno, U.S. Pat. No. 7,534,356; Girodet et al., U.S. Pat. No. 7,947,228; Chang, US 2004/0140269; and Girodet, US 2006/0192135. The relevant content of these documents is incorporated by reference herein.

One type of existing UV water disinfection system employs UV lamps within a flow tank that accommodates open channel water flow. As the water flow increases and decreases, however, the hydraulic characteristics change and certain zones within the flow tank may experience lower flow rates while other zones within the flow tank may experience higher flow rates. A weir or similar device is utilized on the discharge side to regulate the level of water within the flow tank regardless of the flow rate. Another UV water disinfection system utilizes water flow tubes and adjacent UV lamps, such that the lamps do not contact the water.

### BRIEF SUMMARY

An exemplary embodiment of an ultraviolet-based disinfection system includes a fluid flow tube configured to accommodate fluid to be treated, and a UV energy source adjacent to the fluid flow tube. The UV energy source is configured to emit UV energy for treating fluid flowing within the fluid flow tube. The fluid flow tube is configured to inhibit open channel flow conditions and to promote plug flow conditions.

Another exemplary embodiment of an ultraviolet-based fluid disinfection system includes a housing having a fluid entry side and a fluid exit side, and a fluid flow tube configured to accommodate fluid to be treated between the fluid entry side and the fluid exit side. The fluid flow tube has an upwardly tilted exit section that terminates at or near the fluid exit side of the housing. The upwardly tilted exit section is configured to inhibit open channel flow conditions and to promote plug flow conditions within the fluid flow tube.

Another exemplary embodiment of an ultraviolet-based fluid disinfection system includes a housing having a fluid entry side and a fluid exit side, a plurality of fluid flow tubes configured to accommodate fluid to be treated between the fluid entry side and the fluid exit side, and a fluid outlet structure located at the fluid exit side and in fluid communication with the plurality of fluid flow tubes. The fluid output structure is configured to inhibit open channel flow conditions and to promote plug flow conditions within the plurality of fluid flow tubes.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a simplified schematic representation of an exemplary embodiment of a water disinfection system;

FIG. 2 is a simplified perspective view of a stage of the system shown in FIG. 1;

FIG. 3 is a simplified schematic representation of a cross-sectional view through a stage of the system depicted in FIG. 1;

FIG. 4 is a simplified side view of an exemplary embodiment of a stage suitable for use in a UV-based water disinfection system;

FIG. 5 is an end view of the stage as viewed from line 5-5 in FIG. 4;

FIG. 6 is an end view of the stage as viewed from line 6-6 in FIG. 4;

FIG. 7 is a diagram that illustrates an open channel flow condition within a fluid flow tube;

FIG. 8 is a diagram that illustrates a plug flow condition within a fluid flow tube;

FIG. 9 is a simplified side view of another embodiment of a stage suitable for use in a UV-based fluid disinfection system;

FIG. 10 is a simplified side view of yet another embodiment of a stage suitable for use in a UV-based fluid disinfection system;

FIG. 11 is a perspective view of an exemplary embodiment of a fluid outlet structure suitable for use with a stage of a UV-based fluid disinfection system; and

FIG. 12 is a perspective view of another embodiment of a fluid outlet structure suitable for use with a stage of a UV-based fluid disinfection system.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

For the sake of brevity, conventional techniques related to system control, fluid dynamics, ultraviolet-based disinfection, water treatment, and other functional aspects of the systems (and the individual operating components of the systems) may not be described in detail herein. Furthermore, connecting lines shown in any figures contained herein are intended to represent exemplary functional relationships and/or physical couplings between the various elements. It should be noted that many alternative or additional functional relationships or physical connections may be present in an embodiment of the subject matter.

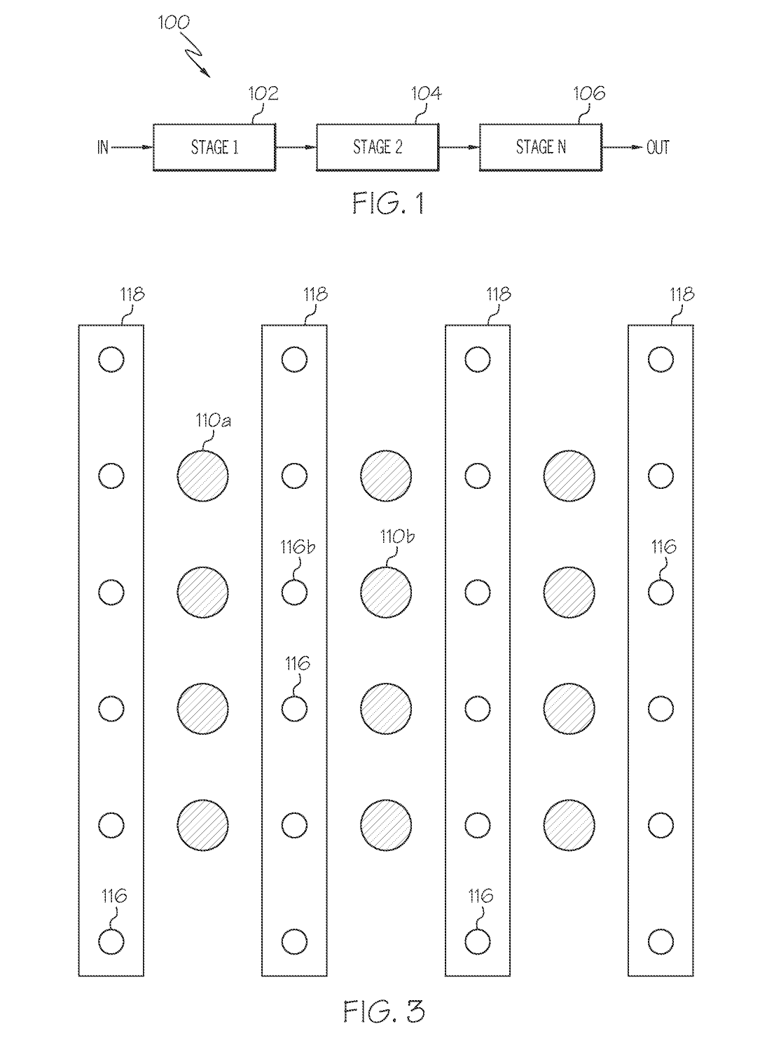

FIG. 1 is a simplified schematic representation of an exemplary embodiment of a fluid disinfection system 100 that utilizes ultraviolet light technology to disinfect water flowing through the system 100. Although this description assumes that the fluid under treatment is water, the disinfection system and technology disclosed herein could be modified to treat and disinfect other fluids and liquids if so desired. For the sake of generality, the system 100 is depicted as a multistage embodiment in that the system 100 includes a first stage 102, a second stage 104, and so on. In practice, the system 100 may include only one stage (i.e., the first stage 102 by itself), only two stages (i.e., only the first stage 102 in series with the second stage 104), or any number of stages in series with one another. The first stage 102 receives water to be treated (represented by the “IN” label). The final stage 106 emits treated water (represented by the “OUT” label). In a multistage implementation as depicted in FIG. 1, the output of the first stage 102 serves as the input to the second stage 104, the output of the second stage 104 serves as the input to the final stage 106, and so on. In this regard, water flows through the system 100 in series through the various stages. In practice, each stage of the system 100 may be similarly configured in accordance with the following description. Notably, the system 100 does not utilize an open channel flow scheme. Moreover, the system 100 need not maintain the input and/or output water levels at any defined height. In this regard, the system 100 need not include a weir at the outlet side, or anything functionally equivalent to a weir.

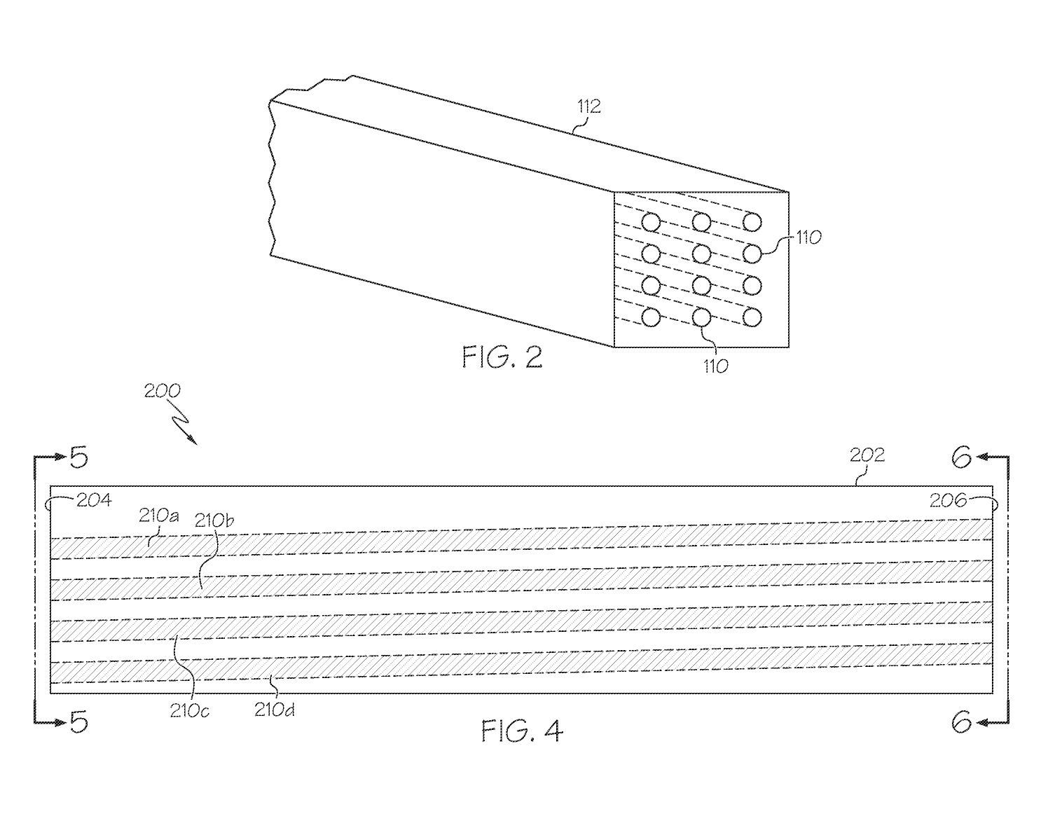

FIG. 2 is a simplified perspective view of a stage 112 of the system 100, and FIG. 3 is a simplified schematic representation of a cross-sectional view through a stage of the system 100. FIG. 2 has been simplified to depict a typical arrangement of water flow tubes 110, which may be arranged along the major longitudinal axis of the stage 112. The number, shape, size, and arrangement of tubes 110 within any given stage may vary from one embodiment to another. For ease of illustration and description, the embodiment depicted in FIG. 2 and FIG. 3 includes twelve tubes 110 arranged in a three-by-four configuration. In a multistage implementation, each tube continues from one stage to another. In other words, each tube 110 in the first stage 102 is coupled to a respective and corresponding tube 110 in the second stage 104, and so on. For example, the tube 110a (depicted in the top left position in FIG. 3) has a corresponding tube 110a in each of the stages and in the same relative position.

Referring to FIG. 3, the stage also includes a plurality of ultraviolet lamp fixtures 116 that are designed to emit ultraviolet radiation to disinfect water as it flows through the tubes 110. In FIG. 3, each of the larger (shaded) circles represents a flow tube 110, and each of the smaller circles represents a lamp fixture 116 (i.e., a UV disinfecting lamp). Although not required in all embodiments, the exemplary implementation illustrated in FIG. 3 has the lamp fixtures 116 configured and arranged in lamp racks 118 that flank the tubes 110. In practice, a stage in the system 100 may have any number of lamp racks 118, and each lamp rack 118 may include any number of lamp fixtures 116. In the illustrated embodiment, the lamp fixtures 116 are substantially aligned with the tubes 110. In this regard, all but two of the rows in FIG. 3 includes three tubes 110 and four lamp fixtures 116. The uppermost and the lowermost rows in FIG. 3 include four lamp fixtures 116, but no tubes 110. Consequently, each tube 110 is surrounded by six neighboring lamp fixtures 116, two of which are immediately adjacent to and flanking the tube 110.

Although not separately shown in FIG. 2, the lamp fixtures 116 in the system 100 are preferably arranged in a longitudinal configuration such that they run substantially parallel to the tubes 110. In alternative embodiments, however, one or more of the lamp fixtures 116 could be perpendicularly arranged relative to the major longitudinal axis of the tubes 110. In yet other embodiments, the lamp fixtures 116 and the tubes 110 need not be orthogonally arranged relative to one another. Moreover, any combination of parallel, perpendicular, and/or non-orthogonal arrangements could be utilized if so desired.

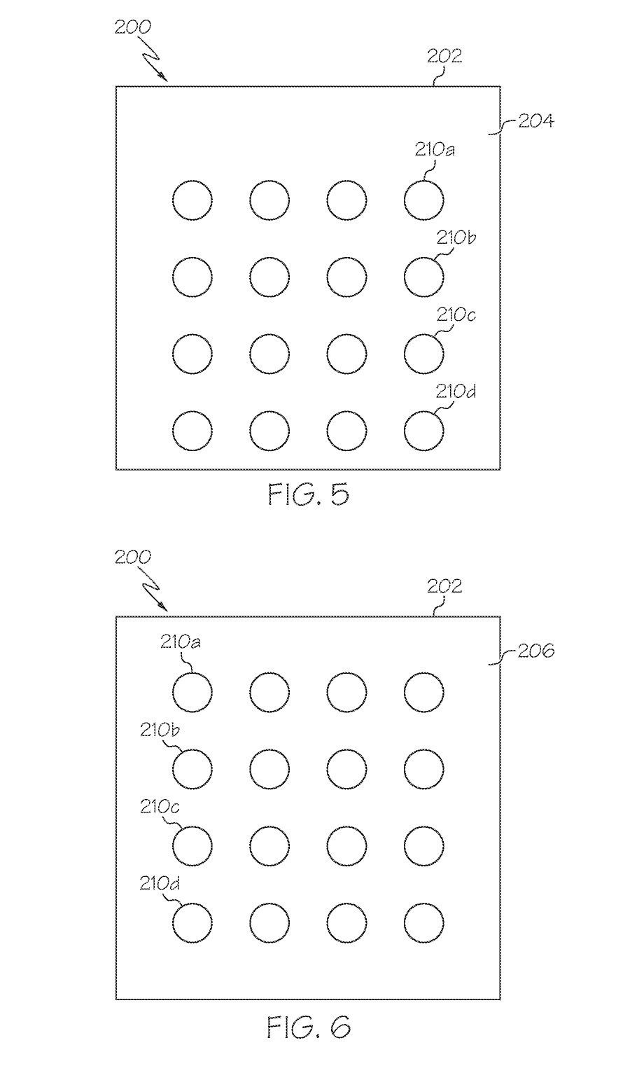

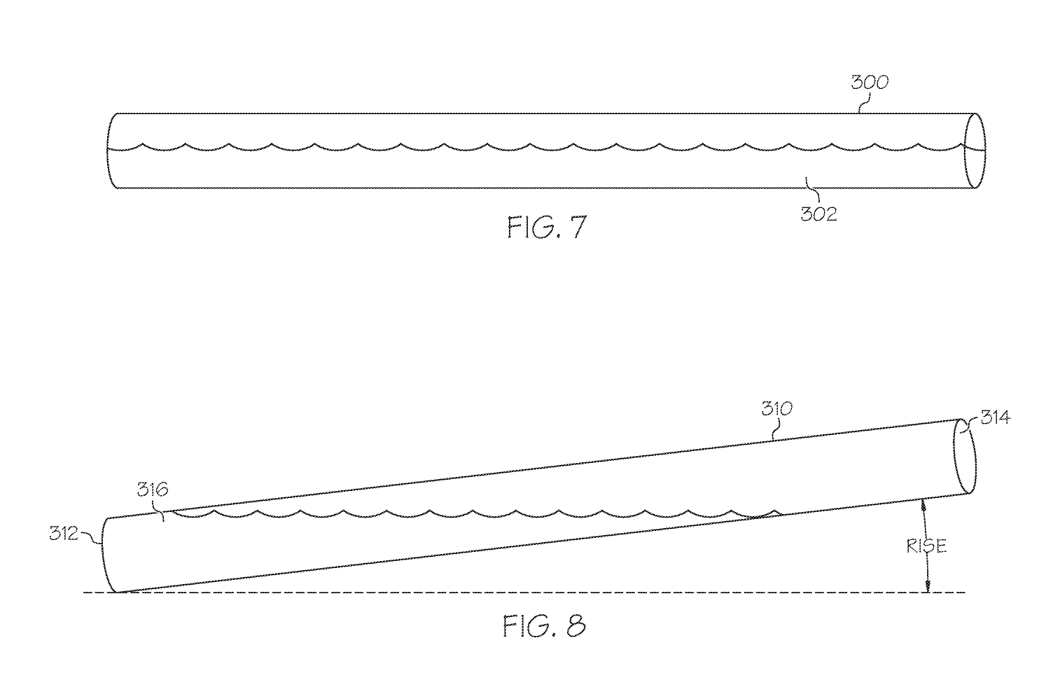

FIG. 4 is a simplified side view of an exemplary embodiment of a stage 200 suitable for use in a UV-based fluid disinfection system, such as the water disinfection system described above with reference to FIGS. 1-3. FIG. 5 is an end view of the stage 200 as viewed from line 5-5 in FIG. 4, and FIG. 6 is an end view of the stage 200 as viewed from line 6-6 in FIG. 4. The stage 200 includes a housing 202 having a fluid entry side 204 and a fluid exit side 206. FIG. 5 corresponds to an elevation view of the fluid entry side 204, and FIG. 6 corresponds to an elevation view of the fluid exit side 206. The housing 202 includes a plurality of fluid flow tubes 210 located and maintained therein (as described previously with reference to FIGS. 1-3), wherein the fluid flow tubes 210 are configured to accommodate the fluid to be treated, e.g., water. Although not always required, the illustrated embodiment includes sixteen fluid flow tubes 210 that are generally oriented in a four-by-four arrangement. In this regard, there are four “levels” of tubes (horizontally aligned in FIG. 5 and FIG. 6). Notably, the fluid flow tubes 210 are angled or tilted within the housing 202 such that their input ends are lower than their output ends. The angled pitch of the fluid flow tubes 210 is discernible in FIG. 4, which shows the fluid flow tubes 210 in dashed lines.

Each fluid flow tube 210 is accessible from the fluid entry side 204 and from the fluid exit side 206. Thus, water to be treated can enter the fluid flow tubes 210 via the fluid entry side 204, and water that has been treated can exit the fluid flow tubes 210 via the fluid exit side 206. For the embodiment depicted in FIGS. 4-6, the inlet end of each fluid flow tube 210 terminates at or near the fluid entry side 204, and the outlet end of each fluid flow tube 210 terminates at or near the fluid exit side 206. As described above with reference to FIGS. 1-3, the stage 200 includes at least one UV energy source adjacent to each fluid flow tube 210, wherein the UV energy source is configured to emit UV energy for treating the fluid as it flows within the fluid flow tubes 210 between the fluid entry side 204 and the fluid exit side 206.

Although not shown in the figures, the fluid entry side 204 of the stage 200 may include additional features, structures, or components that are designed to deliver and accommodate the incoming fluid to be treated. For example, the fluid entry side 204 of the stage 200 may include or cooperate with a tank, an input reservoir, a fluid conduit, a pump system, or the like. For this particular example, as flow increases at the inlet side, the water level increases because the head loss increases (higher flow requires more energy to pass fluid through a fixed tube size). As the water level increases, the fluid flow tubes 210 begin to fill from the lowermost row (level) to higher rows. Referring to FIGS. 4-6, the lower level of fluid flow tubes 210d will be the first to flow, followed by the second level of fluid flow tubes 210c and the third level of fluid flow tubes 210b. The upper level of fluid flow tubes 210a will be the last to flow.

Some conventional UV water treatment systems utilize an outlet tank having a weir that maintains the water level at a desired height to ensure that all of the tubes remain filled during operation. The downside to that approach is that, during low flow conditions, there may not be enough water flowing through the tubes (there could be a minimum flow rate that the system is designed for, to sustain turbulent flow, which in turn results in a self-cleaning action). With a weir system at the output side, the desired minimum flow rate may not always be achieved.

In practice, the system 100 need not utilize an outlet weir, and need not maintain a specified water level. Instead, the system 100 can be operated such that the water level is self-regulated based on the water pressure and inlet flow rate. As the inlet flow rate drops, the pressure required to push the water through the system 100 drops. This results in a decrease in the inlet water level. Accordingly, some of the upper fluid flow tubes 210 may be void of water, while only the lower fluid flow tubes 210 remain full and flowing. In other words, the water level in the stage 200 can vary such that certain fluid flow tubes 210 may be empty or not completely full of water at any given time.

The exemplary embodiments described here contemplate the scenario where a tube is not completely full and, therefore, is exhibiting an open channel flow condition (as depicted in FIG. 7). FIG. 7 depicts a relatively level or horizontally oriented tube 300 having water 302 flowing through it. The water 302 does not completely fill the tube 300 and, therefore, the flow of water 302 through the tube 300 resembles an open channel. The techniques and technology presented here are intended to inhibit or prevent channel flow conditions within the fluid flow tubes 210. To this end, the fluid flow tubes 210 are suitably configured to inhibit open channel flow conditions and to promote plug flow conditions (as depicted in FIG. 8). FIG. 8 depicts an upwardly tilted and angled fluid flow tube 310, wherein the inlet end 312 of the fluid flow tube 310 is lower than the outlet end 314 of the fluid flow tube 310. Thus, at least a portion of the fluid flow tube 310 exhibits a plug flow condition, where the water 316 has completely filled the fluid flow tube 310.

As shown in FIG. 4 and FIG. 8, the fluid flow tubes 210, 310 are arranged and maintained in position within the housing 202 such that the fluid flow tubes 210, 310 have a predetermined amount of rise associated therewith (from the inlet end to the outlet end). In other words, there is a height differential wherein the outlet end of each fluid flow tube 210, 310 is higher in elevation than the inlet end. The rise in the fluid flow tubes 210, 310 prevents water from flowing through any given tube unless there is sufficient pressure and flow energy to completely fill at least a primary section of the tube and, therefore, to establish a plug flow condition.

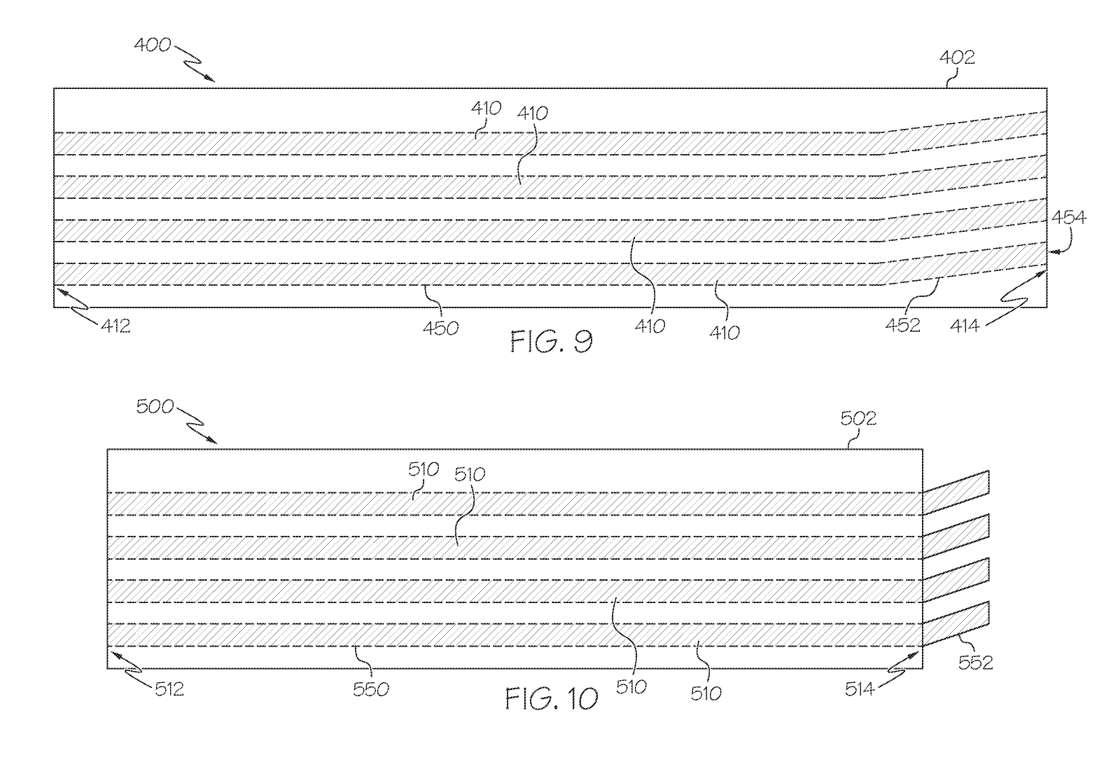

In practice, the amount of rise for a given fluid flow tube 210, 310 must be greater than the diameter of that tube. This minimum rise ensures that a plug flow state will be established within the fluid flow tube 210, 310. In this regard, FIG. 8 depicts a state where the fluid flow tube 310 has not yet reached a total plug flow state. The rise of the fluid flow tube 310 inhibits open channel flow for a period of time. It should be appreciated that a typical operating environment will provide more than enough pressure and energy at the inlet end 312 to overcome the rise in the fluid flow tube 310 and gravitational forces associated with “pushing” the water uphill. In operation, water will remain trapped inside of a partially filled fluid flow tube 310 until the point where the fluid flow tube 310 becomes completely filled. At that time, the water in the fluid flow tube 310 will have reached the outlet end 314, where it can be discharged as usual under plug flow conditions. The predetermined rise can be achieved by tilting the entire length of the fluid flow tubes 210 within the housing 202 (see FIG. 4), or by tilting only an exit section of an otherwise horizontally oriented fluid flow tube, such that the upwardly tilted exit section terminates at or near the fluid exit side 206 of the housing 202 (see FIG. 9 and FIG. 10).

The embodiment depicted in FIG. 4 utilizes sixteen fluid flow tubes 210, each of which is maintained in a position within the housing that results in the same predetermined amount of rise (within practical tolerances). In alternative embodiments, however, different amounts of rise may be utilized for different fluid flow tubes, for different rows of tubes, or the like. In yet other embodiments, some of the fluid flow tubes may have little to no rise, while others have some amount of rise.

FIG. 9 is a simplified side view of another embodiment of a stage 400 suitable for use in a UV-based fluid disinfection system. The stage 400 may include a number of features and functionality that have already been described above in the context of the system 100 and the stage 200; common features, functions, and aspects will not be redundantly described in detail here in the context of the stage 400.

As depicted in FIG. 9, the stage 400 includes a plurality of fluid flow tubes 410 located within a housing 402. Each fluid flow tube 410 is characterized by a primary section 450 and an upwardly tilted exit section 452 that is fluidly coupled to the primary section 450 (for simplicity and clarity, these sections are only labeled for the bottom fluid flow tube 410 in FIG. 9). Although not shown in FIG. 9, a fluid flow tube 410 may also include one or more additional sections, e.g., a transition section fluidly coupled between the primary section 450 and the upwardly tilted exit section 452.

The primary section 450 includes or defines the inlet end 412 of the fluid flow tube 410, and the tilted exit section 452 includes or defines the outlet end 414 of the fluid flow tube 410. The outlet end 414 terminates at an exit opening 454 of the fluid flow tube 410; the treated water flows out of the exit opening 454. In certain embodiments, the exit opening 454 is positioned at a height that is above the height of the primary section 450. In this regard, the exit opening 454 exhibits a rise relative to the level of the primary section 450 and, therefore, relative to the inlet end 412 of the fluid flow tube 410. As mentioned above, the rise associated with the upwardly tilted exit section 452 is configured to inhibit open channel flow conditions and to promote plug flow conditions within the fluid flow tube 410.

The fluid flow tubes 410 shown in FIG. 9 are contained within the housing 402. In alternative embodiments, at least a portion of the upwardly tilted exit sections protrude from the housing. One alternative configuration of this type is shown in FIG. 10, which illustrates a stage 500 having a housing 502 and a plurality of fluid flow tubes 510. The stage 500 may include a number of features and functionality that have already been described above in the context of the system 100 and the stages 200, 400; common features, functions, and aspects will not be redundantly described in detail here in the context of the stage 500.

As depicted in FIG. 10, each fluid flow tube 510 includes a primary section 550 and an upwardly tilted exit section 552 that is fluidly coupled to the primary section 550 (for simplicity and clarity, these sections are only labeled for the bottom fluid flow tube 510 in FIG. 10). In contrast to the configuration shown in FIG. 9, the upwardly tilted exit section 552 is located outside of the housing 502. In alternative embodiments, one segment of the upwardly tilted exit section 552 is located within the housing 502, and the terminating segment of the upwardly tilted exit section 552 extends outside of the housing 502 (this alternative configuration is not shown in the figures). Thus, the primary sections 550 of the fluid flow tubes 510 are nominally horizontal and level within the confines of the housing 502. The upwardly tilted exit sections 552, however, provide a predetermined amount of rise from the inlet ends 512 to the outlet ends 514 of the fluid flow tubes 510, which inhibits open channel flow conditions and promotes plug flow conditions in the manner described previously.

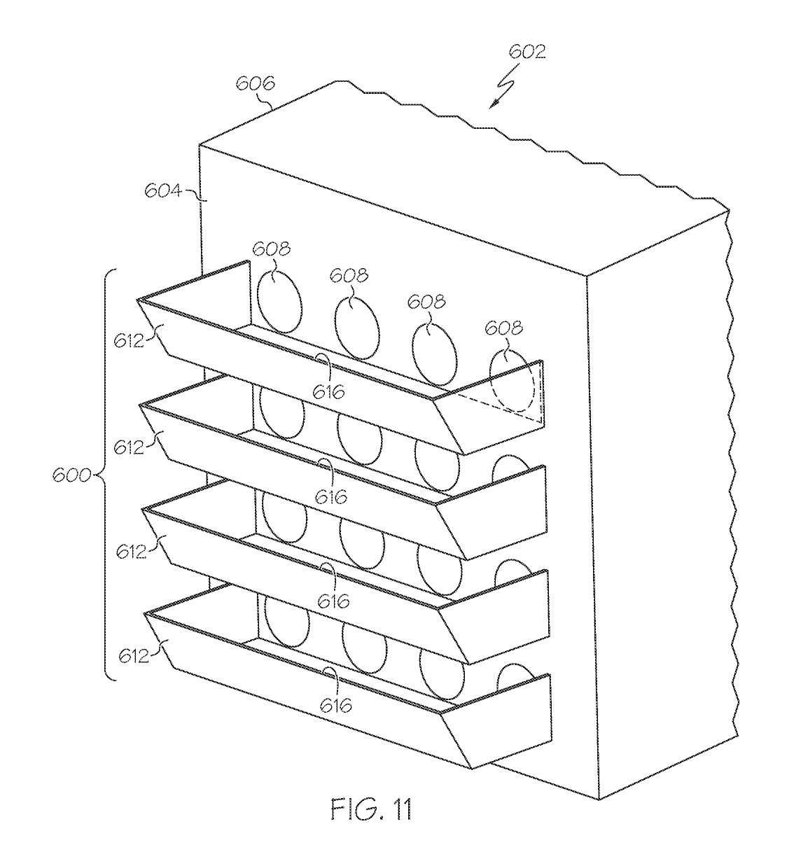

In lieu of (or in addition to) tilted tubes or tilted exit sections, a stage of a UV-based fluid disinfection system may include a suitably configured fluid outlet structure that is designed to inhibit open channel flow conditions and is designed to promote plug flow conditions. In this regard, FIG. 11 is a perspective view of an exemplary embodiment of a fluid outlet structure 600 suitable for use with a stage 602 of a UV-based fluid disinfection system. The stage 602 may include a number of features and functionality that have already been described above in the context of the system 100 and the stages 200, 400, 500; common features, functions, and aspects will not be redundantly described in detail here in the context of the stage 602.

For simplicity and clarity, FIG. 6 only depicts a fluid exit side 604 of the housing 606 of the stage 602. The exit openings 608 of the fluid flow tubes terminate at (or extend from) the fluid exit side 604. Only the uppermost row of exit openings 608 are numbered in FIG. 11; there are sixteen fluid flow tubes and, therefore, sixteen exit openings 608. The fluid flow tubes, which are hidden from view in FIG. 11, may be level and horizontal within the housing 606, they may be tilted as shown in FIG. 4, or they may have a level primary section coupled to a tilted exit section as shown in FIG. 9. In some embodiments, the stage 602 may include any combination of the various types of fluid flow tubes described here.

The fluid outlet structure 600 is located at the fluid exit side 604 of the housing 606. In certain embodiments, the fluid outlet structure 600 is attached to (or is integrated with) the fluid exit side 604. The fluid outlet structure 600 is arranged such that it is in fluid communication with the fluid flow tubes, and such that it promotes plug flow conditions within the fluid flow tubes. In accordance with the embodiment depicted in FIG. 11, the fluid outlet structure 600 includes a plurality of fluid retention troughs 612, each coupled to the fluid exit side 604. Each fluid retention trough 612 may be assigned to one or more of the fluid flow tubes. The illustrated embodiment includes fluid flow tubes arranged and maintained within the housing 606 at a plurality of different levels (heights), wherein a respective one of the fluid retention troughs 612 is assigned to each level. As shown in FIG. 11, one fluid retention trough 612 serves as a collection basin for the lowermost row of exit openings 608, another fluid retention trough 612 serves as a collection basin for the uppermost row of exit openings 608, and so on. In alternative configurations, there could be one fluid retention trough 612 per fluid flow tube, or there could be any number of fluid flow tubes assigned to a given fluid retention trough 612.

Each fluid retention trough 612 functions to collect the treated water that flows out of the fluid flow tubes. In this regard, each fluid retention trough 612 is shaped and sized to inhibit open channel flow within the fluid flow tubes. Thus, each fluid retention trough 612 has an overflow edge 616 that is positioned at a height that promotes plug flow conditions within the fluid flow tubes. During operation, the treated water pools within the fluid retention troughs 612, allowing the water to fill the fluid flow tubes to achieve the plug flow conditions. Eventually, the level of the discharged water rises above the overflow edges 616, and the treated water spills over (into an output tank, a fluid conduit, or the like).

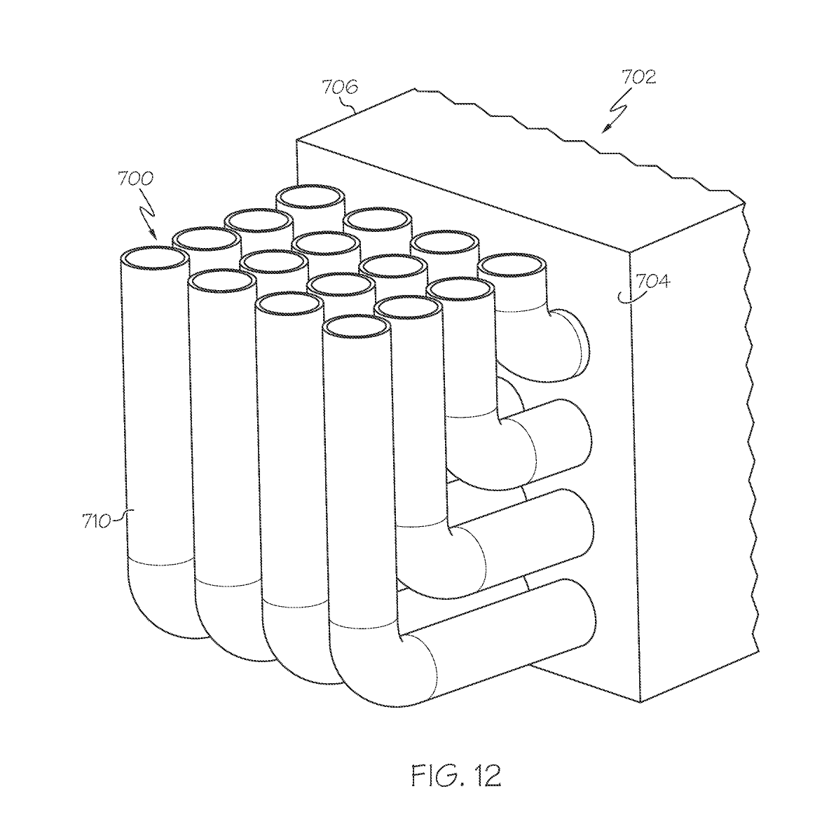

FIG. 12 is a perspective view of another embodiment of a fluid outlet structure 700 suitable for use with a stage 702 of a UV-based fluid disinfection system. The stage 702 may include a number of features and functionality that have already been described above in the context of the system 100 and the stages 200, 400, 500, 602; common features, functions, and aspects will not be redundantly described in detail here in the context of the stage 702.

For simplicity and clarity, FIG. 7 only depicts a fluid exit side 704 of the housing 706 of the stage 702. The fluid flow tubes are hidden from view within the housing 706. The fluid flow tubes may be level and horizontal within the housing 706, they may be tilted as shown in FIG. 4, or they may have a level primary section coupled to a tilted exit section as shown in FIG. 9. In some embodiments, the stage 702 may include any combination of the various types of fluid flow tubes described here.

The fluid outlet structure 700 is located at the fluid exit side 704 of the housing 706. In certain embodiments, the fluid outlet structure 700 includes a plurality of upwardly tilted or curved exit sections 710 associated with the fluid flow tubes. In certain embodiments, the number of exit sections 710 equals the number of fluid flow tubes, such that each exit section 710 is fluidly coupled to a respective one of the fluid flow tubes (as depicted in FIG. 12). In this regard, each exit section 710 may represent an extension of a fluid flow tube maintained within the housing 706.

Although not always required, the illustrated embodiment employs a fluid outlet structure 700 that is suitably configured such that each of the exit sections 710 terminates at a common height. Notably, this common height is located above the height of the uppermost fluid flow tube. This feature is preferred to ensure that all of the fluid flow tubes exhibit plug flow conditions as the water passes through the housing 706.

The particular embodiment shown in FIG. 12 utilizes L-shaped exit sections 710. The horizontal segment of each L-shaped exit section 710 transitions to a vertical segment, which in turn rises to the common fluid outlet height. In accordance with alternative embodiments, the fluid outlet structure 700 may include angled or curved segments that serve as fluid conduits to reach the desired fluid outlet height. In this regard, the fluid outlet structure 700 may resemble the outlet configuration depicted in FIG. 10.

The various embodiments presented here promote plug flow conditions within the primary sections of the fluid flow tubes and, conversely, inhibit open channel flow conditions within the fluid flow tubes. Plug flow is desirable in UV-based water disinfection systems because the water travels through the fluid flow tubes in a relatively uniform flow rate/velocity. A stable and consistent water flow rate ensures that the UV dosage is even and consistent within each stage of the disinfection system.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. An ultraviolet-based disinfection system comprising:
a fluid flow tube configured to accommodate fluid to be treated; and
an ultraviolet energy source adjacent to the fluid flow tube, and configured to emit ultraviolet energy for treating fluid flowing within the fluid flow tube;
wherein the fluid flow tube is configured to inhibit open channel flow conditions and to promote plug flow conditions.

2. The disinfection system of claim 1, further comprising a housing for the fluid flow tube and the ultraviolet energy source, wherein the fluid flow tube is maintained in a position within the housing that results in a predetermined amount of rise from an inlet end of the fluid flow tube to an outlet end of the fluid flow tube.

3. The disinfection system of claim 2, wherein the rise is greater than a diameter of the fluid flow tube.

4. The disinfection system of claim 2, further comprising a plurality of additional fluid flow tubes, wherein each of the additional fluid flow tubes is maintained in a position within the housing that results in the predetermined amount of rise.

5. The disinfection system of claim 1, wherein the fluid flow tube comprises:
a primary section; and
an upwardly tilted exit section fluidly coupled to the primary section.

6. The disinfection system of claim 5, wherein:
the upwardly tilted exit section terminates at an exit opening of the fluid flow tube; and
the exit opening is positioned at a height that is above the primary section.

7. An ultraviolet-based fluid disinfection system comprising:
a housing having a fluid entry side and a fluid exit side; and
a fluid flow tube configured to accommodate fluid to be treated between the fluid entry side and the fluid exit side; wherein:
the fluid flow tube comprises an upwardly tilted exit section that terminates at or near the fluid exit side of the housing; and
the upwardly tilted exit section is configured to inhibit open channel flow conditions and to promote plug flow conditions within the fluid flow tube.

8. The disinfection system of claim 7, further comprising an ultraviolet energy source located within the housing and positioned adjacent to the fluid flow tube.

9. The disinfection system of claim 7, wherein an entire length of the fluid flow tube, including the upwardly tilted exit section, is upwardly tilted within the housing.

10. The disinfection system of claim 7, wherein the fluid flow tube is maintained in a position within the housing that results in a predetermined amount of rise from an inlet end of the fluid flow tube to an outlet end of the fluid flow tube.

11. The disinfection system of claim 10, wherein the rise is greater than a diameter of the fluid flow tube.

12. An ultraviolet-based fluid disinfection system comprising:
a housing having a fluid entry side and a fluid exit side;
a plurality of fluid flow tubes configured to accommodate fluid to be treated between the fluid entry side and the fluid exit side; and
a fluid outlet structure located at the fluid exit side and in fluid communication with the plurality of fluid flow tubes, wherein the fluid output structure is configured to inhibit open channel flow conditions and to promote plug flow conditions within the plurality of fluid flow tubes.

13. The disinfection system of claim 12, wherein:
the fluid outlet structure comprises a plurality of upwardly tilted exit sections; and
each of the plurality of upwardly tilted exit sections is fluidly coupled to a respective one of the plurality of fluid flow tubes.

14. The disinfection system of claim 13, wherein each of the plurality of upwardly tilted exit sections terminates at a common height.

15. The disinfection system of claim 12, wherein:
the fluid outlet structure comprises a plurality of L-shaped exit sections; and
each of the plurality of L-shaped exit sections is fluidly coupled to a respective one of the plurality of fluid flow tubes.

16. The disinfection system of claim 15, wherein each of the plurality of L-shaped exit sections terminates at a common height.

17. The disinfection system of claim 12, wherein:
the fluid outlet structure comprises a plurality of fluid retention troughs coupled to the fluid exit side and assigned to the plurality of fluid flow tubes.

18. The disinfection system of claim 17, wherein a respective one of the plurality of fluid retention troughs is assigned to each of the plurality of fluid flow tubes.

19. The disinfection system of claim 17, wherein:
the plurality of fluid flow tubes are arranged and maintained within the housing at a plurality of levels; and
a respective one of the plurality of fluid retention troughs is assigned to each of the plurality of levels.

20. The disinfection system of claim 17, wherein each of the plurality of fluid retention troughs has an overflow edge positioned at a height that promotes the plug flow conditions.
